(19) United States
(12) Patent Application Publication
(10) Pub. No.: US 2011/0064550 A1
(43) Pub. Date: Mar. 17, 2011

(54) Remote Hopper Release

(75) Inventors: Michael David Genter, Clarkston, MI (US); David Bryan Vinson, Livonia, MI (US)

(73) Assignee: ROURA MATERIAL HANDLING, INC., Clinton Township, MI (US)

(21) Appl. No.: 12/558,719

(22) Filed: Sep. 14, 2009

(51) Int. Cl. B65G 65/23

(52) U.S. Cl. 414/425

(57) ABSTRACT

A remote trip lever release system for application to a self dumping hopper having a base platform, a rotatable dump body mounted thereto and a latching mechanism having a trip lever engageable with a locking pin on the dump body and configured to control the rotation of the dump body thereon is provided. The trip lever release system includes a base assembly comprising a longitudinally extending hollow member mountable to the base platform. An extendable release arm is moveable within the hollow member from a closed or compact position to an open or extended position to lengthen the release system. A release cable has a first end, engageable with the trip lever of the latching mechanism, and a second end. The release cable is operable from the second end to disengage the trip lever from the locking pin on the dump body.

### FIELD OF THE INVENTION

The invention relates to the field of portable containers for the transportation of materials and, more specifically, to a self dumping hopper having a system for the remote actuation of the self dumping action.

### BACKGROUND

The statements in this section merely provide background information related to the present disclosure and may or may not, constitute prior art.

Containers or hoppers are typically used in manufacturing operations to facilitate the movement of various materials. Self dumping hoppers are one genre of container that are frequently used to collect scrap material (such as from machining for instance). Self dumping hoppers may include a specialize configuration that allows for relatively simple handling and movement by a forktruck and ease of emptying as well.

A base platform is provided that includes spaced slots or an opening that is configured to accept the tines of a fork truck for lifting, moving and placement purposes. Mounted on the base platform is a dump body that is adapted to rest upright on the base during filling of the hopper but that includes a geometry that, especially when filled, is biased to allow the hopper to be easily tilted towards an emptying position. A latching mechanism associated with the base platform is operable to engage a locking pin extending from the back of the dump body to maintain the dump body in its upright, fill position. Latching mechanisms commonly in use employ a spring biased handle that may be actuated (often by the fork truck operator), once the self dumping hopper or material handling container has been moved into position for emptying, to allow the dump body to rotate or hinge open from a side or bottom into a second, emptying position. Such devices typically require that the forktruck operator disembark from the forktruck, and its protective surroundings, and manually activate the latching mechanism handle to initiate the emptying process.

Latching mechanisms that are remotely controlled have been introduced. Such devices often include hydraulic actuators that require a fluid connection to the hydraulic system of the fork truck, if available. These devices are costly and require an interface with the forktruck which may either be unavailable, require retrofitting or the purchase by the customer of specific forktrucks. In addition, hydraulic devices that are associated with the hydraulic system of the forktruck require a connect/disconnect operation by the operator each time that a hopper is moved, resulting in lowered efficiency. Other, less costly devices have included pull cords and pulley systems that are mounted to the forktruck, the forktruck upright, the fork carriage assembly or a combination thereof. Such devices also require integration of the release system with the fork truck which may be unavailable, require retrofitting or the purchase by the customer of specific forktrucks.

### SUMMARY

In an exemplary embodiment a remote trip lever release system for application to a self dumping hopper having a base platform, a rotatable dump body mounted thereto and a latching mechanism having a trip lever engageable with a locking pin on the rotatable dump body and configured to control the rotation of the rotatable dump body thereon is provided. The trip lever release system includes a base assembly comprising a longitudinally extending member mountable to the base platform adjacent to the latching mechanism. An extendable release arm having a first end engaging the extending member and a second end opposite the first end, the extendable release arm moveable relative to the extending member from a closed or compact position to an open or extended position to lengthen the base assembly. A release cable has a first end, engageable with the trip lever of the latching mechanism, and a second end. The release cable is operable from the second end to disengage the trip lever from the locking pin on the rotatable dump body.

In another exemplary embodiment a self dumping hopper comprises a base platform having openings configured to accept the fork tines of a fork truck. A dump body is mounted on the base platform and has a first, fill position relative to the base platform and is rotatable along the base platform towards a second, emptying position. A latching mechanism is mounted on the base platform adjacent to the rotatable dump body and is engageable with a locking pin extending from the rotatable dump body to hold the dump body is in the first, fill position. A remote trip lever release system is mounted on the base platform adjacent to the latching mechanism and comprises a base assembly having a longitudinally extending hollow member, an extendable release arm having a first, inner end slidingly received in the hollow member and a second, outer end extending from the hollow member. The extendable release arm is moveable within the hollow member from a closed or compact position to an open or extended position to lengthen the base assembly. A release cable has a first end engageable with the trip lever of the latching mechanism and a second end. The release cable is operable from the second end to disengage the trip lever from the locking pin on the rotatable dump body to rotate the dump body along the base platform towards the second, emptying position.

The above features and advantages, and other features and advantages of the present invention are readily apparent from the following detailed description of the best modes for carrying out the invention when taken in conjunction with the accompanying drawings.

### BRIEF DESCRIPTION OF THE DRAWINGS

Other objects, features, advantages and details appear, by way of example only, in the following detailed description of embodiments, the detailed description referring to the drawings in which:

FIGS. 1A and 1B are schematic side views of a fork truck and self dumping hopper in various modes of operation and embodying features of the present invention;

FIG. 2 is a side view of a self dumping hopper, illustrating a dumping mode in phantom, and embodying features of the present invention;

FIG. 3 is a rear view of the self dumping hopper of FIG. 2, embodying features of the present invention;

FIG. 4 is a view of the remote trip lever release system in a compact mode embodying features of the present invention;

FIGS. 5A and 5B are views of the remote trip lever release system in an extended mode embodying features of the present invention; and

FIG. 6 is an end view of the remote trip lever release system and associated latching mechanism embodying features of the present invention.

### BRIEF DESCRIPTION OF THE EMBODIMENTS

The following description is merely exemplary in nature and is not intended to limit the present disclosure, application or uses. It should be understood that throughout the drawings, corresponding reference numerals indicate like or corresponding parts and features.

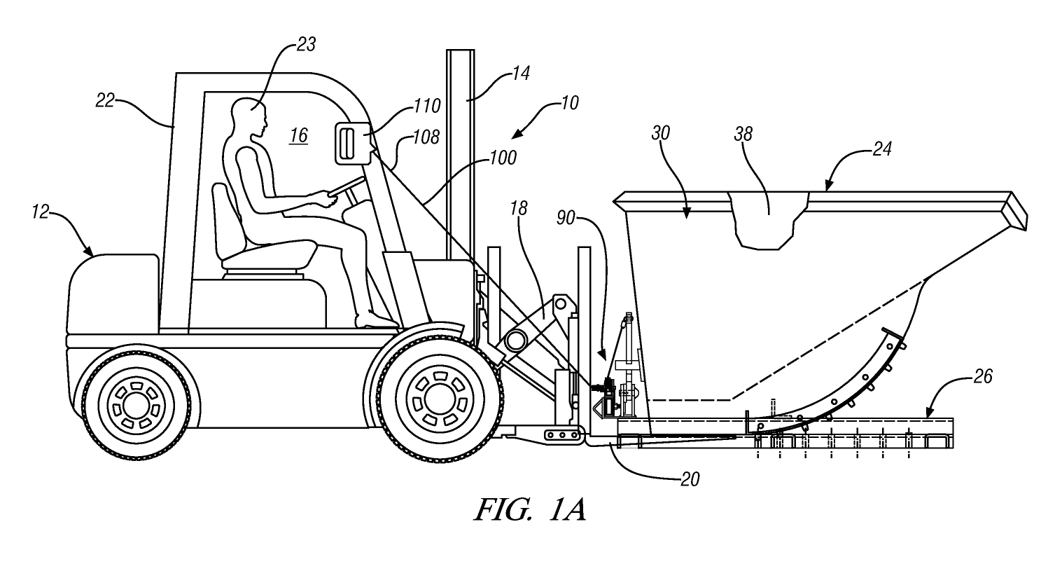

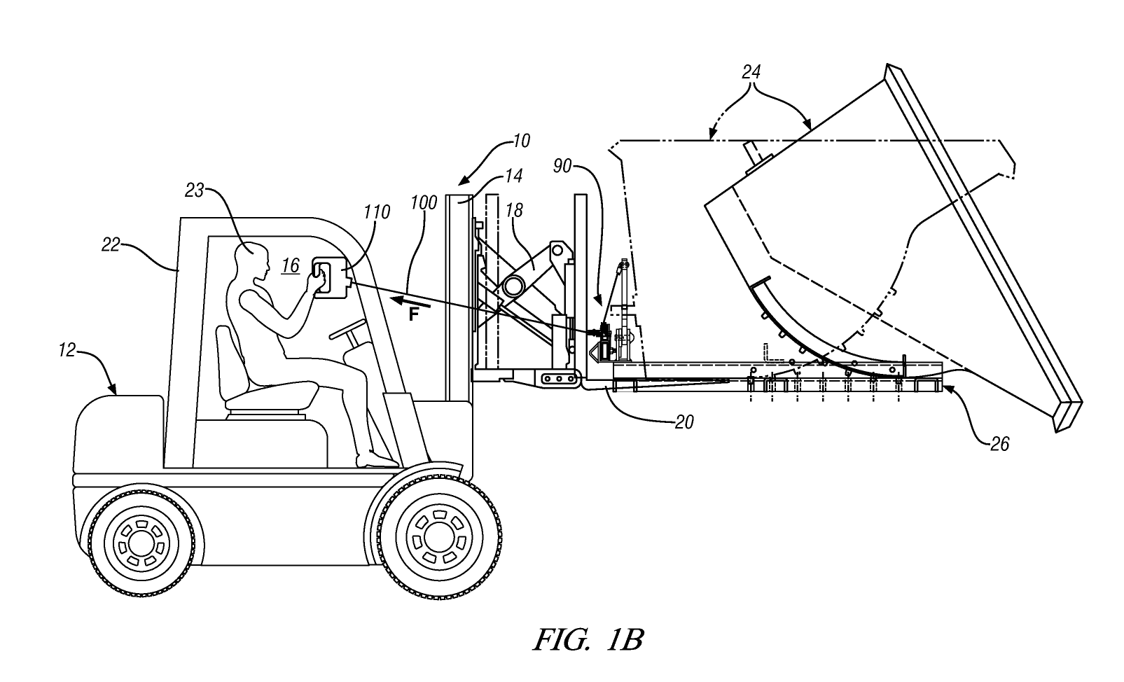

In accordance with an exemplary embodiment, FIGS. 1A and 1B schematically illustrate a fork truck 10 having a wheel supported body section 12, an upright 14, an operators compartment 16, outrigger arms 18 extending forwardly of the body section 12, and a pair of fork tines 20 associated with the outrigger arms 18 for engaging a variety of cargo that is moveable and placeable by the fork truck. The fork truck 10 may include a safety cage 22 that extends about and defines the operator's compartment 16, and is intended to protect the operator 23 should cargo being moved/placed by the fork truck 10 become unstable and fall. It should be apparent that, during operation of the fork truck 10, the operator is in the safest location when he or she remains in the operators compartment 16 surrounded by the safety cage 22.

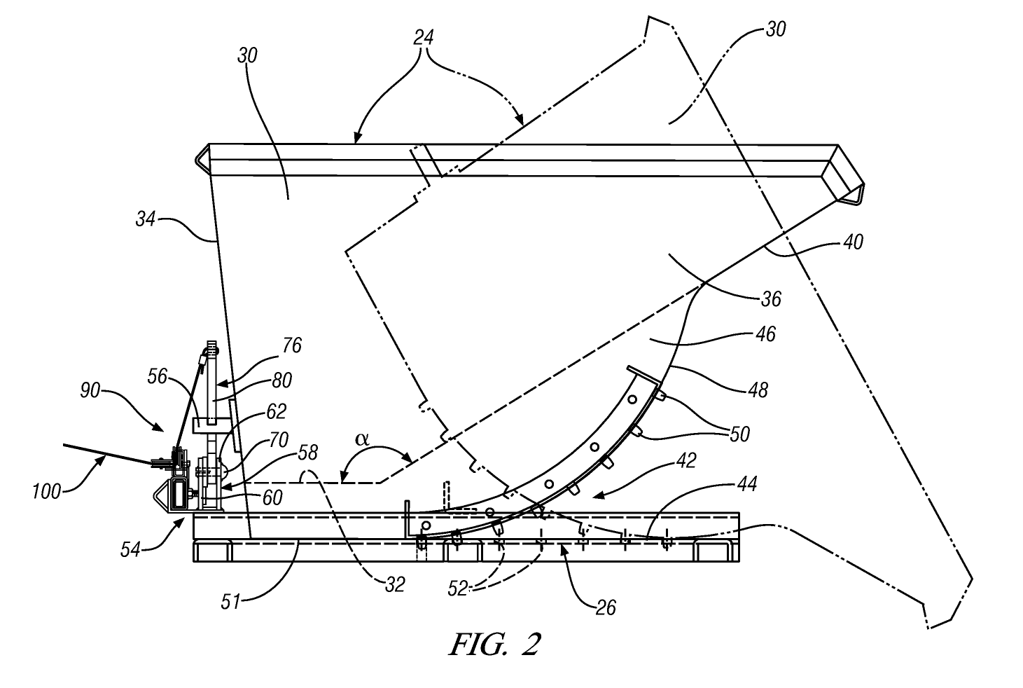

Referring to FIGS. 1, 2 and 3, a self dumping hopper (hopper) 24 is provided. The hopper 24 includes a base platform 26 that includes a lift opening or openings 28 that are configured to accept the fork tines 20 of the fork truck 10 for the purpose of lifting, moving and positioning the hopper 24 by the fork truck 10. The opening(s) 28 may be defined by supports 29 that extend below and support the base platform 26. Mounted on the base platform 26 is a dump body 30 that includes a planar bottom portion 32 adapted to rest in a generally parallel relationship to the base platform 26 when the dump body 30 is retained in a first, upright position for filling or storing of material. Back and side panels 34 and 36, respectively, extend upwardly from the bottom portion 32 to partially define an interior container portion 38 of the dump body 30. A front panel 40 completes the interior container portion 38 and extends from the horizontal bottom portion 32 outwardly (i.e. towards the front of the hopper 24) at an angle (“a”) such that the surface area of the front panel 40 is greater than that of the bottom portion 32 to thereby define a dump body geometry that, especially when filled, is biased to allow the hopper to be easily tilted forward, towards a second, emptying position, shown in phantom in FIG. 2.

In an exemplary embodiment, a tracked pivoting system, referred to generally as 42, is incorporated into the base platform 26 and the dump body 30 and is configured to provide for controlled emptying of the dump body 30 of the self dumping hopper 24. The tracked pivoting system 42 includes trunion tracks 44 that extend longitudinally from front to back along the outer edges of the base platform 26. Rocker plates 46 extend downwardly from the outer edges of side panels 36 to terminate in curved edge surfaces 48 that are configured to engage, and roll along, the trunion tracks 44 allowing the dump body 30 to be rotated in a forward (and backward) direction. The curved edge surfaces 48 terminate in rearward extending flat portions 51 that will maintain the dump body 30 in the first, upright position for filling or storing of material. Spaced trunion pins 50 extend outwardly from the curved edge surfaces 48 of the rocker plates 46 and are configured to engage a series of spaced openings 52 in the trunion tracks 44 during rotation of the dump body 30. The engagement of the trunion pins 50 with the spaced openings 52 in the trunion tracks 44 operate to confine the dump body 30 against lateral shifting movement as it is tilted. Suitable stops (not shown) will limit the forward rotating movement of the dump body 30.

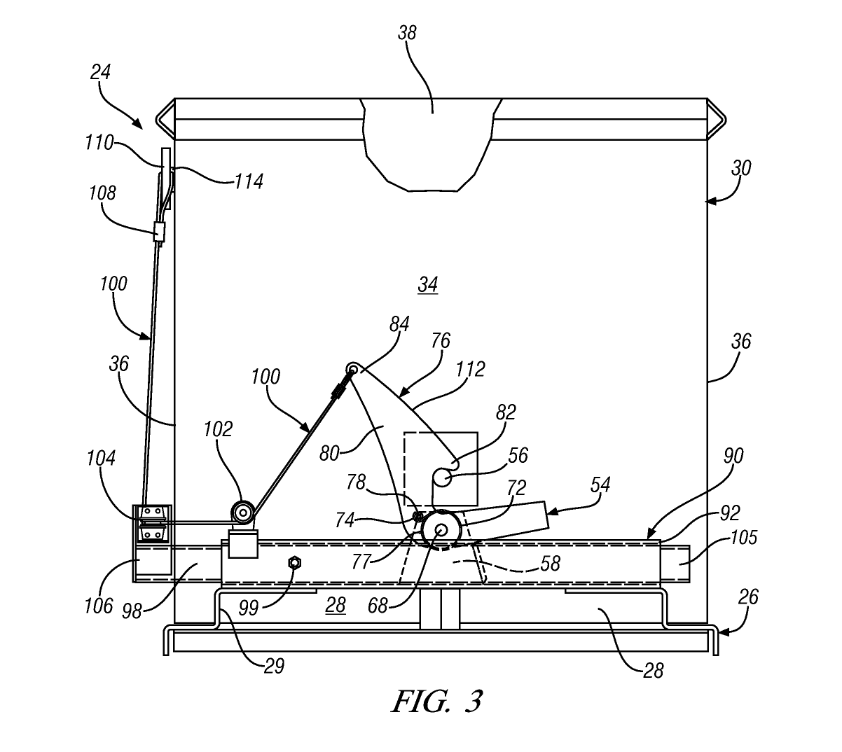

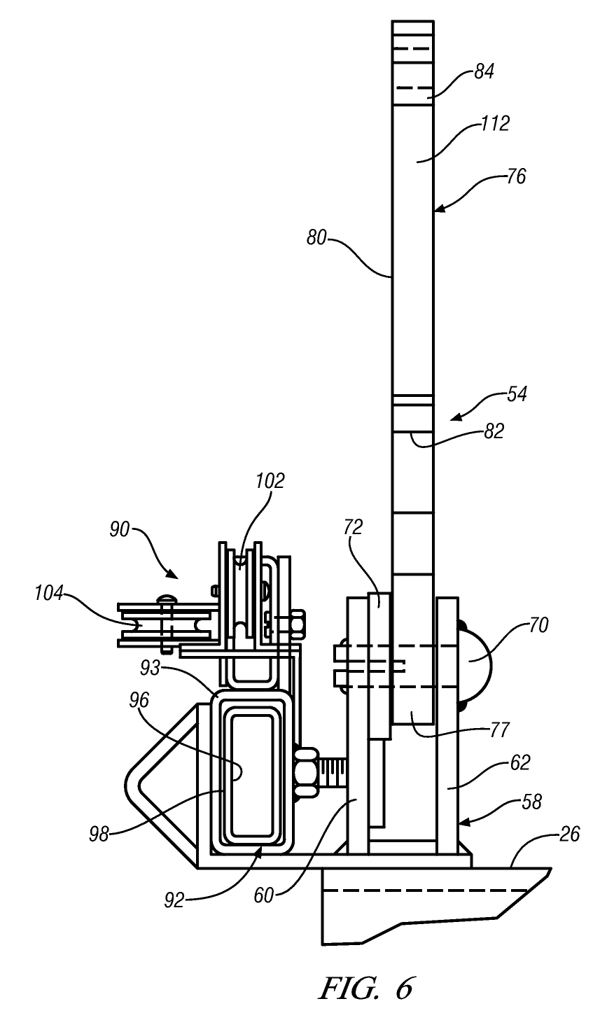

In an exemplary embodiment illustrated in FIGS. 3-6, a latching mechanism, referred to generally as 54 is associated with the base platform 26 and is configured to engage a locking pin 56 that extends from the back panel 34 of the dump body 30. It is also contemplated that the locking pin 56, or additional locking pins 56, may extend from a side panel 36, and include a latching mechanism closely associated therewith, without deviating from the scope of the invention. In an exemplary embodiment, the latching mechanism 54 may be configured to include a double bracket 58 that is welded or otherwise fixed to the base platform 26 and extends upwardly therefrom. The double bracket 58 includes spaced bracket portions 60 and 62 that each include openings that share a common axis 68 for receipt of a pivot pin 70 therein. The pivot pin 70 is configured to receive, and anchor, a first end (not shown) of a concentric coil spring 72. A second end 74 of the concentric coil spring is secured at securing point 78, to a first end 77 of a trip lever 76 that is pivotally mounted on the pivot pin 70, adjacent to the concentric coil spring 72 and between the spaced bracket portions 60, 62. The trip lever has an upwardly extending arm portion 80 that includes a hook portion 82 located intermediate of the first end 77 and a second end 84 thereof. The hook portion is adapted to extend over the locking pin 56 on the dump body 30 to maintain the dump body 30 securely in its first, fixed or fill position (i.e. for receiving or storing material). The concentric coil spring 72 is preloaded such that it urges the hook portion 82 of the trip lever 76 into engagement with the locking pin 56, as a default. It should be appreciated that the embodiment described discloses the use of a concentric coil spring for biasing the trip lever 76 into a latched position with respect to the locking pin 56 of the dump body 30. However, it is contemplated that other suitable biasing mechanisms such as extension springs, spring loaded struts, torsion springs and the like may be used as well.

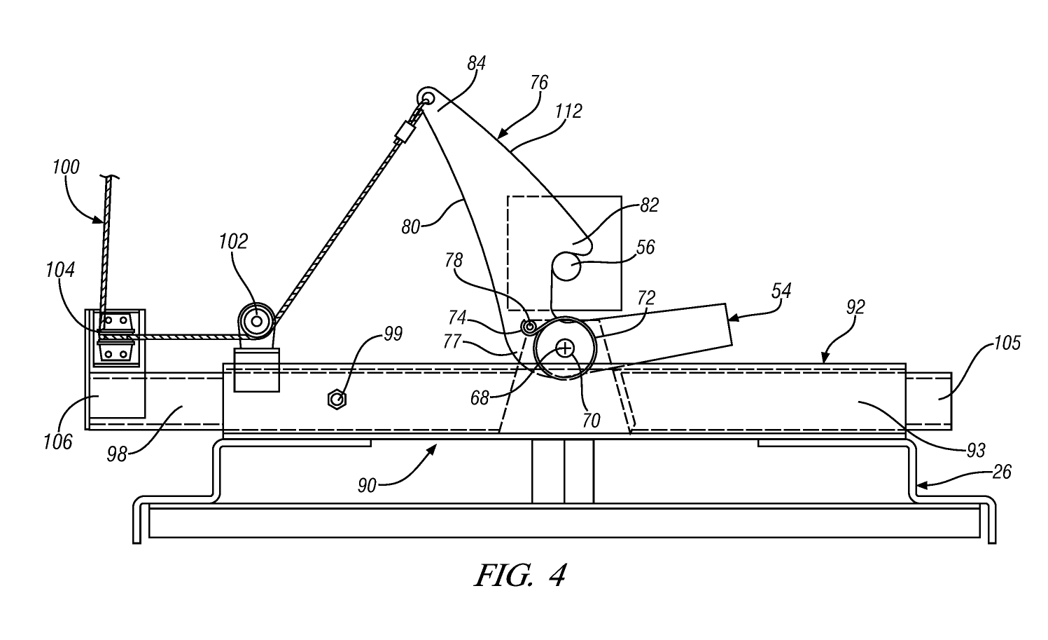

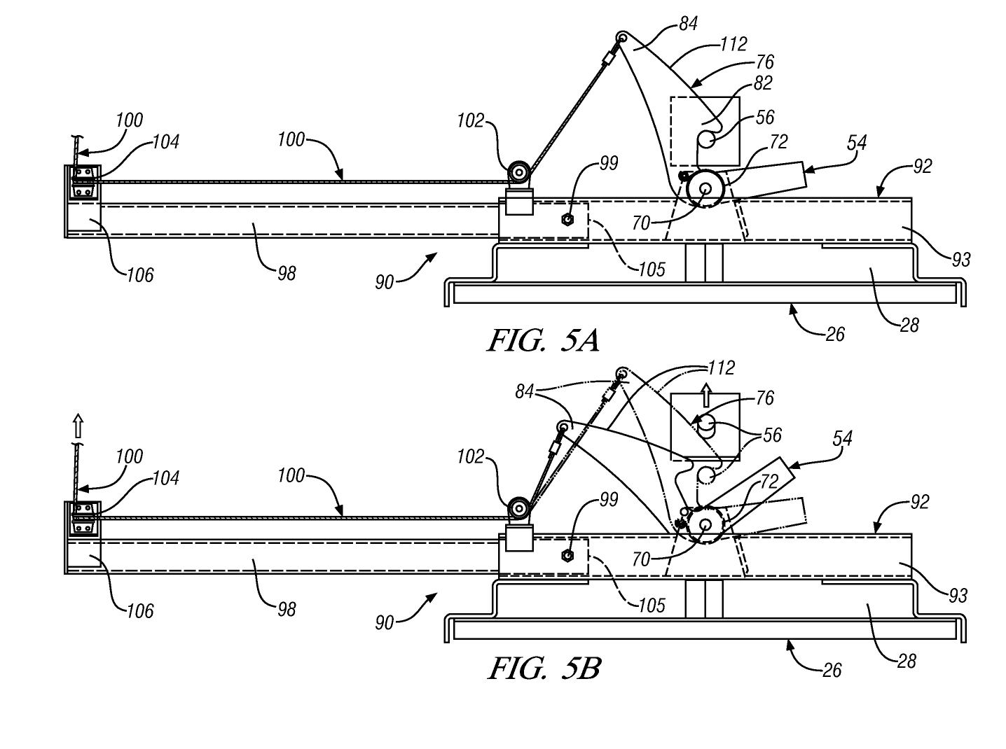

In order to release the trip lever 76, to thereby allow for forward pivoting of the dump body 30 to a second, emptying position, FIG. 2, a remote trip lever release system, referred to generally as 90 is provided. The remote trip lever release system 90 includes a base member 92 that extends, in an exemplary embodiment, longitudinally across the rear of the base platform 26 and is fixed to the base by welding, fasteners, or the like. In the exemplary embodiment shown in the figures, the base member 92 comprises a longitudinally extending, hollow box member 93 that defines an opening 96 that is configured to slidingly receive a first, inner end 105 of an extendable release arm 98 therein. A second, outer end 106 of the extendable release arm 98 protrudes outwardly from the opening 96 of the hollow box member 93. The extendable release arm 98 is moveable within the opening 96 of the hollow box member 93 from a closed or compact position shown in FIG. 4 to an open or extended position shown in FIGS. 5A and 5B. A stop such as thumb screw or spring loaded pin 99 that is attached to a side of the base assembly 92 is useful to fix the release arm 98 in position (closed/compact or open/extended) with respect to the base assembly 26. By operating the thumb screw or spring loaded pin 99 it can be urged into contact with the extendable release arm 98 to thereby fix it in position. Releasing the thumb screw or spring loaded pin 99 will allow the extendable release arm 98 to move freely relative to the hollow box member 93. While the base assembly 92 has been described as including a hollow box member 93 with a similarly shaped extendable release arm 98 slidingly mounted therein, it is also contemplated that other configurations of base assembly 92 that utilize, for instance, hollow cylinders with similarly configured extendable release arms may also be utilized with equal performance without deviating from the scope of the invention. In addition, tracked, rack or hinged assemblies having base and extendable members that are moveable relative to one another (closed/compact or open/extended relative to the base assembly) are also contemplated

In an exemplary embodiment, the remote trip lever release system 90 further includes a release cable 100 having a first end in fixed communication with the second end 84 of the upwardly extending arm portion 80 of the trip lever 76. The release cable 100 may pass through a first control guide such as pulley 102 that is fixed to the hollow member 93 and subsequently extends along the extendable release arm 98 to pass through a second control guide such as pulley 104 that is fixed to the second, outer end 106 of the extendable release arm 98. The release cable 100 terminates at a second end 108, and may terminate in conjunction with a cable extension apparatus such as a reel 110 that serves to change the useable length of the release cable 100 to be lengthened or shortened dependent upon the position of the extendable release arm 98 with respect to the base assembly 92, as well as other factors to be discussed herein. The reel 110 may include a winding mechanism or spring biased mechanism or any other suitable apparatus capable of extending or reducing the length of the release cable 100, as required, during operation. In an exemplary embodiment the reel 110 will have an attaching means such as a magnet, a hook, opposing hook and loop surfaces (Velcro®) or other suitable securing apparatus 114 for removably securing the cable extension apparatus to the fork truck 10, when the fork truck tines 20 have engaged the spaced slots 28 of the base 26, FIG. 1 or, to a back or side panel 34 or 36 when the self dumping hopper 24 is being used to collect or store material, FIG. 3.

In an exemplary embodiment, the remote trip lever release system 90 includes two primary configurations for use in two primary modes of operation of the self dumping hopper 24. In a first mode of operation, shown in FIGS. 3. and 4, the release arm 98 is stowed in the compact position within the base assembly 92. In this mode, the cable extension apparatus 110 has retracted the overall length of the release cable 100 to a length that allows the cable extension apparatus to be mounted, magnetically or otherwise to a side panel 36 or back panel 34 of the dump body 30. In the first mode of operation, the self dumping hopper 24 is typically not engaged with a fork truck 10 and is positioned for receipt of parts or material that is to be stored therein. In a second mode of operation shown in FIGS. 1A, 5A and 5B, the fork truck 10 has engaged the self dumping hopper 24 by slidingly engaging its fork tines 20 into the opening or openings 28 in the base platform 26 thereof. The operator of the fork truck has extended the release arm 98 to a position in which the second, outer end 106 of the extendable release arm 98, as well as the second pulley 104 that is disposed at the second, outer end of the release arm has cleared the outermost edge of the wheel supported body section 12 of the fork truck 10. The cable extension apparatus 110 has been operated to extend the overall length of the release cable 100 to a length that allows the cable extension apparatus to be attached via securing apparatus 114, magnetically or otherwise, to the fork truck 10 in close proximity to the operators compartment 16 (ex. to the safety cage 22, for instance).

In the configuration of the remote trip lever release system 90 described for the second mode of operation of the self dumping hopper 24, the apparatus is configured to allow the fork truck operator to lift, move and empty the hopper without exiting the safe confines of the operators compartment 16, FIG. 1B. The self dumping hopper 24 may be raised and moved by the fork truck 10 without any interconnection or interference with the wheel supported body section 12, the upright 14, the outrigger arms 18 or other functional components thereof. Additionally the remote trip lever release system 90 is completely self-contained on the assembly of the self dumping hopper 24 and requires no physical interaction (hydraulic or mechanical), save the removably attached cable extension apparatus 110.

When the fork truck 10 has positioned the self dumping hopper 24 in an appropriate position for emptying its contents, FIG. 1B, the fork truck operator grasps the cable extension apparatus 110 (which is locked against extension of further cable length) and pulls on the release cable 100. The force exerted on the release cable 100 by the operator will result in a downward acting force on the second end 84 of the upwardly extending arm portion 80 of the trip lever 76. The trip lever 76 and associated hook portion 82 will rotate counter clockwise, shown in phantom in FIG. 5B, about the pivot pin 70 and against the bias of the concentric coil spring 72, to disengage the hook portion from the dump body locking pin 56. Upon such disengagement, the weight biased dump body 30 will be urged by its load biased geometry to be easily tilted forward on trunion tracks 44 towards its second, emptying position, shown in phantom in FIG. 1B. The self dumping action just described is carried out by the fork truck operator 23 from the confines of the safety cage protected operators compartment 16. Following emptying of the contents of the dump body 30, its un-weighted state will urge it to pivot rearward on the trunion tracks 44 until the pivot pin 56 engages the inclined face 112 of the trip lever 76 causing the lever to be moved counterclockwise against the bias of the concentric coil spring 72 under the weight of the dump body 30. The dump body will be automatically latched as soon as the locking pin 56 clears the hook portion 82 of the trip lever 76. The remote trip lever release system 90 may now be returned to its closed, compact position and the self dumping hopper 24 placed for further collection or storage of material.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the present application.

What is claimed is:

1. A remote trip lever release system for application to a self dumping hopper having a base platform, a rotatable dump body mounted thereto and a latching mechanism having a trip lever engageable with a locking pin on the rotatable dump body and configured to control the rotation of the rotatable dump body thereon, comprises:
a base assembly comprising a longitudinally extending member mountable to the base platform adjacent to the latching mechanism;
an extendable release arm having a first end engaging the extending member and a second end opposite the first end, the extendable release arm moveable relative to the extending member from a closed or compact position to an open or extended position to lengthen the remote trip lever release system; and
a release cable having a first end, engageable with the trip lever of the latching mechanism, and a second end, the release cable operable from the second end to disengage the trip lever from the locking pin on the dump body.

2. The remote trip lever release system of claim 1, further comprising:
a cable extension apparatus attached to the second end of the release cable and configured to extend or reduce the overall length of the release cable.

3. The remote trip lever release system of claim 2, wherein the cable extension apparatus includes a removable attachment to secure the apparatus to a side of the dump body when the extendable release arm is in a closed or compact position.

4. The remote trip lever release system of claim 3, wherein the cable extension apparatus may be removably secured to a fork truck when the fork truck is engaged with the self dumping hopper and the extendable release arm is in an open or extended position.

5. The remote trip lever release system of claim 3, wherein the removable attachment comprises a magnet, a hook, opposing hook and loop surfaces (Velcro®) or other suitable method for removably securing the cable extension apparatus to the dump body or to a fork truck.

6. The remote trip lever release system of claim 1, further comprising:
a locking mechanism associated with the extending member and configured to engage the extendable release arm to thereby maintain the arm in a closed or compact position or an open or extended position.

7. The remote trip lever release system of claim 6, wherein the locking mechanism is a thumb screw rotatable in a threaded opening in the extending member.

8. The remote trip lever release system of claim 6, wherein the locking mechanism is a spring loaded locking pin mounted to the extending member and configured to engage the extendable release arm.

9. The remote trip lever release system of claim 1, wherein the release cable extends through at least one cable guide on the second, outer end of the extendable release arm.

10. A self dumping hopper comprising:
a base platform configured to engage the fork tines of a fork truck;
a dump body mounted on the base platform and having a first, fill position relative to the base platform and rotatable along the base platform towards a second, emptying position;
a latching mechanism mounted on the base platform adjacent to the dump body and engageable with a locking pin extending from the dump body to hold the dump body is in the first, fill position;
a remote trip lever release system mounted on the base platform adjacent to the latching mechanism comprising:
a base assembly having a longitudinally extending hollow member;
an extendable release arm having a first, inner end slidingly received in the hollow member and a second, outer end extending from the hollow member, the extendable release arm moveable within the hollow member from a closed or compact position to an open or extended position to thereby lengthen the remote trip lever release system; and
a release cable having a first end engageable with the trip lever of the latching mechanism and a second end, the release cable operable from the second end to disengage the trip lever from the locking pin on the dump body to thereby allow rotation of the dump body along the base platform towards the second, emptying position.

11. The self dumping hopper of claim 10, further comprising:
a cable extension apparatus attached to the second end of the release cable and configured to extend or reduce the overall length of the release cable.

12. The self dumping hopper of claim 11, wherein the cable extension apparatus includes a removable attachment to secure the extension apparatus to a side of the dump body when the extendable release arm is in a closed or compact position and the dump body is in the first, fill position.

13. The self dumping hopper of claim 11, wherein the cable extension apparatus may be removably secured to a fork truck when the fork truck is engaged with the self dumping hopper and the extendable release arm is in an open or extended position.

14. The self dumping hopper of claim 12, wherein the removable attachment comprises a magnet, a hook, opposing hook and loop surfaces (Velcro®) or other suitable method for removably securing the cable extension apparatus to the dump body or to a fork truck.

15. The self dumping hopper of claim 10, further comprising:
a locking mechanism associated with the hollow member and configured to engage the extendable release arm to thereby maintain the arm in the closed or compact position or the open or extended position.

16. The self dumping hopper of claim 15, wherein the locking mechanism is a thumb screw rotatable in a threaded opening in the hollow member.

17. The self dumping hopper of claim 15, wherein the locking mechanism is a spring loaded locking pin mounted to the hollow member and configured to engage the extendable release arm.

18. The self dumping hopper of claim 10, wherein the release cable extends through at least one cable guide on the second, outer end of the extendable release arm.
